(19) United States
(12) Patent Application Publication
(10) Pub. No.: US 2015/0108281 A1
(43) Pub. Date: Apr. 23, 2015

(54) Method for monitoring the operation of an aircraft piloting device and an aircraft piloting device thus monitored

(71) Applicant: RATIER FIGEAC, FIGEAC (FR)

(72) Inventor: Cedric ANTRAYGUE, FIGEAC (FR)

(21) Appl. No.: 14/519,333

(22) Filed: Oct. 21, 2014

(30) Foreign Application Priority Data
Oct. 22, 2013 (FR) 13.60261

(51) Int. Cl. B64C 13/10; B64C 13/12; B64C 13/50

(52) U.S. Cl. CPC B64C 13/10; B64C 13/503; B64C 13/12
USPC 244/223; 244/228

(57) ABSTRACT

A method for monitoring an aircraft piloting device including at least one piloting member (20, 30) and at least one fly-by-wire flight control system (40, 41). At least one monitoring module is integrated into this control system and is adapted to compute, on the basis of primary signals processed by sensors associated with at least one piloting member, at least one theoretical value of at least one monitored parameter of at least one piloting member, to compare each theoretical value with measurement signals of each monitored parameter and to select a monitoring action, particularly to generate monitoring signals (55, 56), as a function of the difference between each theoretical value and the measurement signals.

### FIELD OF THE INVENTION

The invention relates to a method for monitoring the operation of an aircraft piloting device, to an aircraft piloting device thus monitored and to an aircraft provided with said piloting device.

Throughout the remainder of the document, the term “piloting” and its derivatives refer, unless otherwise stated, to the flying of an aircraft by at least one human pilot operating at least one piloting member such as a flight stick, a control lever, a rudder bar, a pedal, etc. linked to at least one flight control member, such as a control surface or an engine of the aircraft. The term “flight control member” refers to any member for which the position or the state affects the flight of the aircraft: it can particularly relate to control surfaces, engines, the blades of a rotor, etc. The term “control” and its derivatives in aeronautics conventionally refer to the fact of providing a device with signals that bring about a predetermined action of said device. The term “monitor” and its derivatives in aeronautics conventionally refer to the fact of processing measurements carried out on a device and of comparing them with predetermined values in order to detect the occurrence of operating faults (i.e. faults that originate from any malfunction in a system (device and/or software), particularly as opposed to usage faults that do not originate from a malfunction but from user errors (pilot or co-pilot) or as a result of the aircraft deviating from its flight envelope). A device for monitoring the operation of a piloting device is a device with at least one monitoring function for each piloting member of this piloting device, and which is also able to perform other functions.

### BACKGROUND OF THE INVENTION

Fly-by-wire aircraft piloting devices comprising at least one piloting member and at least one fly-by-wire flight control system with fly-by-wire flight controls are already known. Such a computer system is adapted to compute, as a function of predetermined control laws, and to generate signals for controlling actuators of flight control members (control surfaces, engines, etc.) of the aircraft at least as a function of signals, called primary signals, particularly position signals, delivered by sensors, particularly position sensors, associated with each piloting member.

With such piloting devices, operation needs to be monitored in order to detect operating anomalies within the piloting device and to generate corresponding monitoring signals, which in particular can be warning signals and/or signals capable of inhibiting the control signals and/or signals triggering a modification in the predetermined control laws of the fly-by-wire flight control system.

More particularly, although not exclusively, this is the case when the piloting device is also provided with actuating motors for each piloting member and with at least one control unit (which may or may not be distinct from said fly-by-wire flight control system) and capable of producing signals for controlling said actuating motors, called force feedback signals, so as to generate a simulated force feedback sensation on each piloting member. Furthermore, said control unit particularly can be adapted to realise a servo-coupling (logically and electronically) of piloting members that move along the same degrees of freedom and are connected to the same flight control members, for example a pilot flight stick and a co-pilot flight stick. The motors thus allow the sensation of conventional mechanical flight sticks to be simulated and each flight stick to be followed by the other flight stick.

EP 0759585, on the one hand, provides each flight stick with a motor for generating force feedback sensations with complete redundancy of the motors, detection sensors and circuits for generating force feedback sensations and, on the other hand, provides a force feedback control computer and a distinct monitoring computer, with these computers being linked so as to “self-monitor” the control signal of the motor associated with this flight stick, compare it with a current signal of the motor and compare measured voltage signals with a reference signal, with the monitoring computer monitoring the force feedback control computer, both computers being capable of deactivating the motor. Such a solution, which is conventional in principle, is heavy, complex and costly to implement and to operate. In particular, it requires a specific monitoring computer for each flight stick, which computer is housed in the electromechanical unit on which the flight stick is mounted. It also requires specific position sensors for monitoring, which sensors are distinct from the position sensors used to control the force feedback. Furthermore, it remains imperfect insofar as certain malfunctions that are likely to occur on such a monitoring computer or that simultaneously affect the force feedback chain of command and the monitoring chain, which are close to each other, will not necessarily be detected themselves. Furthermore, in this solution, the monitoring computers need to be designed, developed, manufactured and controlled independently of the force feedback control computers and the fly-by-wire flight control systems.

US2011/0112705 and US2011/0108673 also provide specific force feedback/monitoring control units comprising bi-functional micro-controllers that also have to be specifically adapted to perform the monitoring, independently of the force feedback control, and which also at least partly have the aforementioned disadvantages.

US2012/0053762 discloses an active side-stick and control lever system (“active inceptor system”) comprising a virtual real-time model simulating at least one component of this system, allowing certain state variables to be computed, such as the value of forces, on the basis of other variables that are initially present, and comprising a function for monitoring the system. This monitoring function, which is executed by a control unit of the piloting device, therefore has the same disadvantages as those mentioned above.

US2005/0080495 also discloses a piloting device comprising active piloting members. This document also discloses a fly-by-wire flight control system and indicates that it is possible to use the desired trajectory of the piloting member generated by the trajectory generator as a flight control signal. This document also states that a monitoring device can be provided to detect a faulty piloting member, for example by means of a comparison between the desired trajectory and the actual measured trajectory of this piloting member. This monitoring device therefore has the same disadvantages as those mentioned above.

### SUMMARY OF THE INVENTION

Therefore, the object of the invention is to overcome these disadvantages by proposing a method for monitoring operation, which is highly resilient to a generic malfunction, totally independently of the piloting members that it monitors and, where necessary, of the force feedback control in particular, and which moreover is also provided at a reduced cost of development, is less complex, and allows the bulk of the piloting device to be reduced.

A further object of the invention is to propose a piloting device and an aircraft with the same advantages.

The invention therefore relates to a method for monitoring the operation of an aircraft piloting device comprising:
at least one piloting member;
at least one fly-by-wire flight control system adapted to generate, as a function of predetermined control laws, signals for controlling actuators of flight control members of the aircraft at least as a function of signals, called primary signals, delivered by sensors associated with each piloting member,
said method for monitoring operation being adapted to detect operating anomalies within the piloting device and to generate corresponding monitoring signals and comprising the following steps:
computing, on the basis of at least part of signals delivered by sensors associated with each piloting member and according to at least one predetermined computation law, at least one theoretical value of at least one operating parameter, called monitored parameter, of at least one piloting member;
comparing, for each monitored parameter, each theoretical value with measurement signals delivered by sensors associated with at least one piloting member;
selecting a monitoring action, particularly generating monitoring signals, as a function of the difference between each theoretical value and said measurement signals,
characterised in that said at least one theoretical value is computed on the basis of at least part of said primary signals, and in that it is implemented by at least one monitoring module integrated into a fly-by-wire flight control system.

The invention further relates to an aircraft piloting device comprising:
at least one piloting member;
at least one fly-by-wire flight control system adapted to generate, as a function of predetermined control laws, signals for controlling actuators of flight control members of the aircraft at least as a function of signals, called primary signals, delivered by sensors associated with each piloting member;
at least one module for monitoring the operation of the piloting device adapted to detect operating anomalies within the piloting device and to generate corresponding monitoring signals, and adapted to:
compute, on the basis of signals delivered by sensors associated with each piloting member and according to at least one predetermined computation law, at least one theoretical value of at least one operating parameter, called monitored parameter, of at least one piloting member;
compare, for each monitored parameter, each theoretical value with measurement signals delivered by sensors associated with at least one piloting member;
select a monitoring action, particularly generating monitoring signals, as a function of the difference between each theoretical value and said measurement signals,
characterised in that said at least one monitoring module is integrated into a fly-by-wire flight control system, and in that said at least one monitoring module is adapted to compute said at least one theoretical value on the basis of said primary signals.

The invention further relates to an aircraft provided with a piloting device according to the invention.

In effect, the inventors have noted that it is in fact possible to monitor the operation of a piloting device by the simple additional programming of at least one fly-by-wire flight control system (FCS) and without requiring the addition of further specific sensors, particularly position sensors and/or force sensors, designed for this monitoring. In contrast to that which has already been considered, in reality the result is better operational reliability of the monitoring, which becomes independent of the piloting members and of their electromechanical mounting unit. Furthermore, these monitoring benefits from safeties and redundancies that are already provided within fly-by-wire flight control systems.

In particular, in a method and a device according to the invention, said at least one monitoring module is executed by at least one central processing unit of a fly-by-wire flight control system adapted to generate, as a function of predetermined control laws, signals for controlling actuators of flight control members of the aircraft at least as a function of said primary signals, and not by a central control unit of the piloting device and/or of a device generating an active force feedback in at least one piloting member.

In particular, in a piloting device, each piloting member is mounted on an electromechanical unit and is supported by said unit. Advantageously and according to the invention, each central processing unit of a fly-by-wire flight control system executing a monitoring module according to the invention is located outside of each electromechanical unit of each piloting member, generates monitoring signals outside of each electromechanical unit of each piloting member and delivers these signals to the input of each electromechanical unit of each piloting member.

Various operating parameters can be selected by way of monitored parameter. In particular, advantageously and according to the invention, when the piloting device is provided with electric actuating motors at least one distinct parameter of the electric supply current of such an actuating motor is used by way of monitored parameter. In particular, this leads to more reliable monitoring, with the value of the supply current of the motors being able to vary due to causes other than an operating anomaly and, reciprocally, certain operating anomalies not necessarily being expressed by a modification of the value of the supply current of the motors.

Furthermore, the invention allows any type of monitoring of various piloting members to be carried out, i.e. direct monitoring in particular (with the primary signals, the theoretical values, the monitored parameters all relating to the same piloting member) and/or cross-monitoring (with the primary signals being delivered by sensors associated with a first piloting member and/or with a first degree of freedom of a piloting member, whereas the theoretical values and the monitored parameters relate to another piloting member and/or to a second degree of freedom of a piloting member).

Moreover, the measurement signals can be measurement signals of one or more monitored parameters delivered by sensors for this one or more monitored parameter or, otherwise, can be measurement signals of a parameter other than the monitored parameter, with at least one theoretical value of the monitored parameter being computed on the basis of measurement signals of at least one other parameter distinct from the monitored parameter.

Advantageously and according to the invention, at least one monitored parameter of at least one piloting member is a distinct parameter of the position of the piloting member. Furthermore, advantageously and according to the invention, for each theoretical value of a monitored parameter, said measurement signals compared to this theoretical value are measurement signals of the same monitored parameter, particularly of the monitored parameter of the same piloting member. However, preferably, advantageously and according to the invention, said primary signals that are used to compute at least one theoretical value of a monitored parameter are signals delivered by sensors measuring a parameter other than the monitored parameter. Advantageously and according to the invention, said primary signals comprise position signals of at least one piloting member and at least one monitored parameter is a parameter other than the position of this piloting member. All other variants are possible.

In particular, advantageously and according to the invention, at least one monitored parameter is selected from the position of the piloting member and the forces imparted to the piloting member.

Therefore, advantageously and according to the invention, said monitoring module is adapted to:
receive primary position and/or force signals from each piloting member of said piloting device, which signals are delivered to the fly-by-wire flight control system by position sensors and/or force sensors associated with each piloting member;
compute, on the basis of said primary position and/or force signals and according to at least one predetermined computation law, at least one theoretical position value of at least one piloting member and/or at least one theoretical value of the forces imparted to at least one piloting member;
receive measurement signals delivered by position sensors associated with at least one piloting member (which may or may not be the same as that for which at least one theoretical value is computed) representing the position of this piloting member and/or by force sensors associated with at least one piloting member representing forces imparted to this piloting member;
compare each theoretical value with said measurement signals so as to be able to detect operating anomalies within the piloting device and to select a monitoring action, particularly to generate corresponding monitoring signals.

More particularly, a method according to the invention is advantageously characterised in that said primary signals comprise position signals delivered by position sensors associated with the piloting member, in that the forces imparted to the piloting member are used by way of monitored parameter, and in that at least one theoretical value of static forces is computed by said monitoring module as a function of a predetermined computation law linking the position with the force, and/or in that at least one theoretical value of damping forces is computed by said monitoring module as a function of a predetermined computation law linking the time drift of the position with the force, and/or in that at least one theoretical value of inertia forces is computed by said monitoring module as a function of a predetermined computation law linking the second time drift of the position with the force. In a particularly advantageous embodiment according to the invention, at least one theoretical value of forces that is the algebraic sum of said theoretical values of static, damping and inertia forces is computed by said monitoring module.

Furthermore, advantageously and according to the invention, a second-order transfer function is used to process an error signal as a function of the difference between each theoretical value and said measurement signals.

The invention is more particularly, although not exclusively, applicable to a piloting device of the type that is called “active”, i.e. in which at least one piloting member is associated with at least one actuator adapted to generate a simulated sensation of forces particularly allowing a force feedback to be produced in the piloting member as a function of its position, so as to mimic the behavior of a piloting member that is mechanically linked to a flight control member of the aircraft and/or to couple two piloting members (pilot and co-pilot) acting on the same flight control members.

Thus, a piloting device according to the invention advantageously is further characterised in that it comprises at least one actuating motor for at least one piloting member and at least one force feedback control unit capable of producing signals, called force feedback signals, for controlling each actuating motor so as to generate a simulated force feedback sensation on the piloting member. Advantageously and according to the invention, said at least one monitoring module is executed by a central processing unit of a fly-by-wire flight control system, i.e. a control unit distinct from said at least one force feedback control unit.

Furthermore, advantageously such a piloting device according to the invention comprises at least two piloting members that can move along identical degrees of freedom, linked by at least one fly-by-wire flight control system to the same flight control members of the aircraft, and coupled to each other by said force feedback control unit. Said control unit may or may not be partially formed by a fly-by-wire flight control system, or even by each fly-by-wire flight control system.

Similarly, advantageously and according to the invention, at least one monitoring module is adapted to produce monitoring signals inhibiting at least one force feedback actuating motor, particularly inhibiting said force feedback signals and/or the electric power supply of at least one force feedback actuating motor when the difference between each theoretical value and said measurement signals is greater by absolute value than a predetermined threshold value corresponding to an operating anomaly.

The invention further relates to a monitoring method, a piloting device and an aircraft, which in combination are characterised by all or part of the features mentioned above or hereafter.

### BRIEF DESCRIPTION OF THE DRAWINGS

Further objects, features and advantages of the invention will become apparent upon reading the following description, which is provided by way of non-limiting example, and with reference to the appended drawings, wherein:

FIG. 1 is a general diagram of a piloting device according to the invention;

FIG. 2 is a general block diagram of a piloting device according to the invention implementing a monitoring method according to the invention;

FIG. 3 is a general block diagram of a fly-by-wire flight control system of a piloting device according to the invention implementing a monitoring method according to the invention;

FIG. 4 is a functional block diagram of an embodiment of a piloting device according to the invention monitored by a monitoring method according to the invention;

FIG. 5 is a functional block diagram of a first example of a monitoring algorithm that can be implemented by a fly-by-wire flight control system of a piloting device according to the invention in a method according to the invention;

FIG. 6 is a functional block diagram of a second example of a monitoring algorithm that can be implemented by a fly-by-wire flight control system of a piloting device according to the invention in a method according to the invention.

### DETAILED DESCRIPTION OF THE INVENTION

A piloting device according to the invention, as shown in FIG. 1, comprises, in the example, two piloting members 20, 30 allowing an airplane to be piloted by pitch and by roll, each made up of a mini-flight stick supported by an electromechanical unit 25, allowing the mechanical control and the movement of each mini-flight stick by rotation about a pitch axis 26, 36, respectively, and a roll axis 27, 37, respectively. These mini-flight sticks each comprise a control stick 21 (31, respectively), with each control stick being adapted to be handled by a pilot (and a co-pilot, respectively). These control sticks are mounted and guided rotationally relative to the frame 28, 38, respectively, of the unit, along the two axes 26, 27, 36, 37, respectively, that are orthogonal and generally at least substantially intersecting (forming a link with a central point).

In this embodiment of the piloting device, the exerted forces are forces that relate to a rotation and the term “torque” therefore will be used to designate them, without this being interpreted as a restriction, for example in the case of control levers with linear movement where the exerted force is a force along an axis of translation of the control lever.

The mini-flight stick 20, for example, which is dedicated to a pilot (pilot in command), comprises, in series on the pitch axis 26, a torque sensor 24 adapted to provide measured force signals 44 representing the value of the forces, in this case a torque Fp, exerted by the pilot on the control stick 21. The torque sensor 24 is linked on the one hand to the control stick 21 and on the other hand to at least one electric motor 23 adapted to be able to exert a torque on the control stick 21 along the pitch axis 26. The electric motor 23 can, for example, comprise a rotor coupled to the control stick 21 along the pitch axis 26 and a fixed stator integral with the frame 28 of the unit 25 of the piloting member. A position sensor 22 is also mounted in series on the pitch axis 26 and allows position signals 29 to be delivered that represent the angular position θp of the control stick 21 on this axis 26. Of course, each axis 26, 27 of the mini-flight stick can also comprise “passive” elements, such as springs or dampers, linked to the frame 28.

Symmetrically, the mini-flight stick 30 that is intended for a co-pilot comprises a control stick 31, a torque sensor 34 providing measured force signals 45 representing the value of the torque Fcp exerted by the co-pilot on this control stick 31, at least one electric motor 33 able to rotate the control stick 31 about the pitch axis 36 relative to a frame 38 of the unit, and a position sensor 32 delivering position signals 39 representing the angular position θcp of the control stick 31 of the co-pilot about the pitch axis 36.

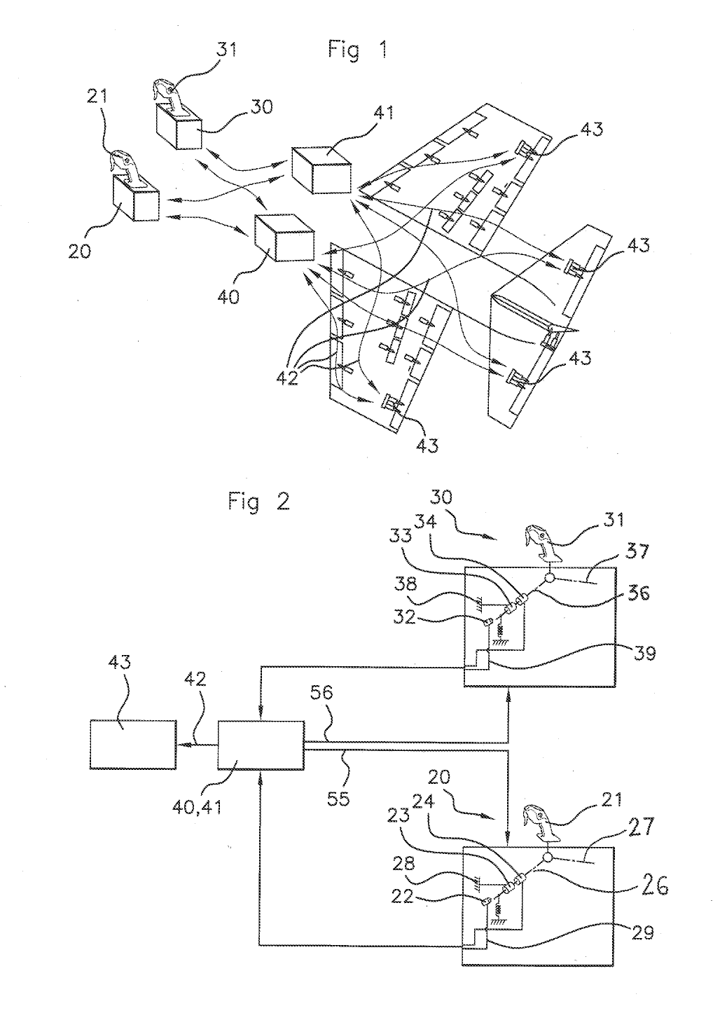

In the example shown in FIG. 2, only the sensors and motors relating to the pitch axis 26, 36 of each piloting member are shown, given that the roll axis 27, 37 also has similar sensors and motors. Furthermore, it will be noted that the various sensors and motors are generally duplicated on each axis for redundancy purposes.

The piloting device shown further comprises two fly-by-wire flight control systems 40, 41 generating, as a function of predetermined control laws and in a manner per se known, signals 42 for controlling actuators 43 of control surfaces of the aircraft by pitch and by roll as a function of the primary position signals 29, 39 delivered by the position sensors 22, 32 associated with each mini-flight stick 20, 30. Each fly-by-wire flight control system 40, 41 is linked to two mini-flight sticks 20, 30 in order to receive the primary signals 29, 39, 44, 45 delivered by the various sensors and, where necessary, to address signals for controlling the motors 23, 33 along each axis of each mini-flight stick 20, 30.

In a piloting device according to the invention, each fly-by-wire flight control system 40, 41 comprises, in addition to a module 50, 51 for conditioning primary signals 29, 39, 44, 45 received from sensors of the two mini-flight sticks 20, 30 and a main module 52 processing signals 42 for controlling actuators 43 of control surfaces, at least one module 53 for monitoring the mini-flight stick 20 of the pilot processing signals 55 for monitoring the operation of this mini-flight stick 20, and at least one module 54 for monitoring the operation of the mini-flight stick 30 of the co-pilot processing signals 56 for monitoring the operation of this mini-flight stick 30.

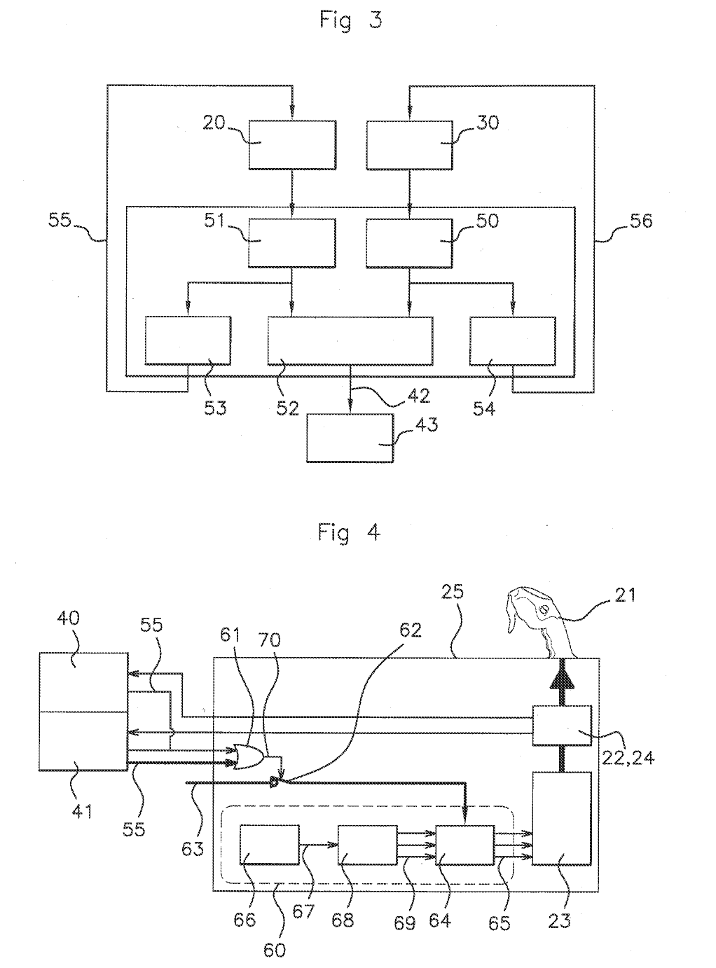

FIG. 4 more specifically shows an embodiment of the method and of the device for monitoring the operation of the mini-flight stick 20 of the pilot, with the same method and the same device being duplicated for monitoring the operation of the mini-flight stick 30 of the co-pilot.

As shown in FIG. 4, the electromechanical unit 25 incorporates a unit 60 for controlling each force feedback motor 23, with this control unit 60 delivering electric power supply signals, called force feedback signals 65, for each force feedback motor 23. This control unit 60 particularly incorporates a servo-control logic unit 66 receiving the measured force signals 44 delivered by the force sensors 24 and possibly the signals 29 delivered by the position sensors 22, with this servo-control logic unit 66 delivering a set point signal 67 of forces to a logic circuit 68 processing logic signals 69 for controlling force feedback motors 23 that are fed to the input of a power circuit 64 delivering the electric power supply signals 65 of the force feedback motors 23.

The signals 55 for monitoring the mini-flight stick 20 of the pilot that are processed by the two fly-by-wire flight control systems 40, 41 are fed into the electromechanical unit 25 to an OR logic gate 61, the output 70 of which commands a switch 62 mounted in series on an electric power supply line 63 of the power circuit 64 supplying each force feedback motor 23. Each monitoring module 53 is adapted to deliver monitoring signals 55 inhibiting the power supply signals 65 of the force feedback motors 23 according to the results of a comparison between at least one theoretical value of at least one monitored parameter of the piloting member and measurement signals delivered by sensors associated with at least one of the piloting members.

The selection of each theoretical value, of the measurement signals and of the comparison logic is adapted to allow the detection of an operating malfunction of the piloting member on one and/or other of the axes 26, 27 of this piloting member.

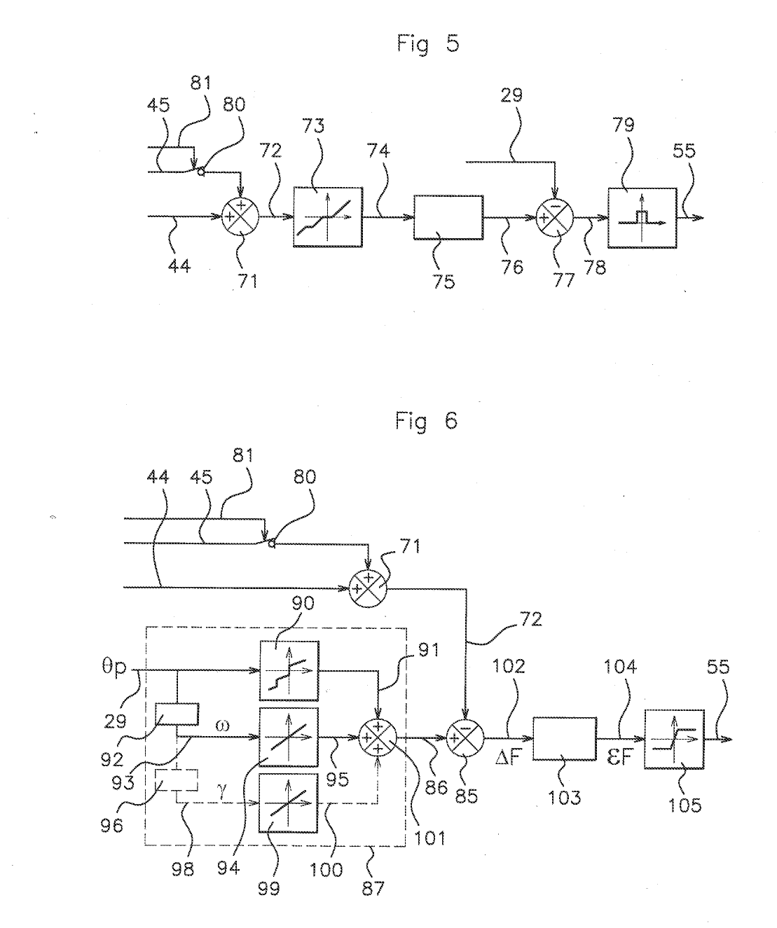

FIGS. 5 and 6 show two embodiments (that can be simultaneously implemented by the same monitoring module) of this comparison logic that can be implemented by the monitoring module 53 of the mini-flight stick 20 of the pilot on one of the pitch axes 26 or roll axes 27, called monitored axis.

In the first variant of FIG. 5, which provides position monitoring, the force signals 44 delivered by the force sensors 24 of the mini-flight stick 20 of the pilot for the monitored axis and the force signals 45 delivered by the force sensors 34 of the mini-flight stick 30 of the co-pilot for the monitored axis are supplied by an adder 71 that combines these signals in order to deliver the measured force signals 72 fed to the input of a logic module 73 applying a predetermined control law stored in a memory of the fly-by-wire flight control system 40 linking the forces applied to the control lever 21 of the mini-flight stick 20 to the theoretical angular position of this stick 21 about the monitored axis.

A series switch 80 controlled by a signal 81 for coupling the two mini-flight sticks 20, 30 allows, when it is open, the two mini-flight sticks to be decoupled, with only the force signals 44 coming from the mini-flight stick 20 of the pilot being used to monitor this mini-flight stick 20. When the switch 80 is closed, the measured force signals 44, 45 for the two mini-flight sticks 20, 30 are used in the monitoring logic. The coupling signal 81 is processed and delivered by the fly-by-wire flight control system 40.

The logic module 73 therefore delivers theoretical position signals 74 of the control lever 21 about the monitored axis. These theoretical position signals 74 are fed to the input of a regulation module 75 applying a transfer function representing the mechanical response of the piloting member, in particular its damping and its inertia (as programmed in the piloting member), which in practice can be a second-order transfer function representing an inertia-spring-damping system. The regulation module 75 delivers a corresponding angular position set point signal 76. This position set point signal 76 is compared by a comparator 77 with the position signals 29 delivered by the position sensors 22, with this comparator 77 effecting the difference AO between these signals 76, 29 in order to deliver signals 78 that represent this difference AO and that are fed to the input of a comparator 79 that delivers the monitoring signals 55 as a function of the absolute value |Δθ| of the difference.

If this absolute value |Δθ| is higher than a stored predetermined threshold, the monitoring signal 55 is placed at a high level that is adapted to open the switch 62 and to inhibit the electric power supply 63 of the power circuit 64 of the force feedback motors 23. In this way, the force feedback motors 23 are no longer supplied.

If the absolute value is lower than said stored predetermined threshold, the monitoring signal 55 is placed at a low level, which in particular is substantially zero, so that the switch 62 remains closed, with the power circuit 64 being fed by the electric power supply 63. The force feedback motors 23 are then operational. Of course, an opposite logic to that described above can be used in the comparator 79.

In the variant of an embodiment of FIG. 6, which monitors forces, the forces measurement signal 72 delivered by the adder 71 is delivered to a negative input of a comparator 85 that receives on a positive input theoretical force signals 86 that are processed by a logic module 87. The logic module 87 receives position θp signals 29 as input that originate from angular position sensors 22 of the mini-flight stick 20. These position signals 29 are transmitted to a first reference table 90 adapted to apply a stored predetermined law linking the angular position of the control lever 21 to the force applied to this control lever 21 so as to provide a first value 91 of static theoretical forces as a function of the position θp.

The position θp signals 29 are also time shifted in a first diverter 92 in order to provide speed signals 93 corresponding to the speed ω of angular displacement of the control lever 21. These speed signals 93 are transmitted to a second reference table 94 adapted to apply a stored predetermined law linking the angular speed to the force applied to the control lever 21 so as to provide a second theoretical damping force value 95 as a function of the speed ω of displacement of the control lever 21.

Similarly, the angular speed signals 93 preferably feed a second diverter 96 delivering acceleration signals 98 representing the angular acceleration of the control lever 21. These acceleration signals 98 are transmitted to the input of a third reference table 99 adapted to apply a stored predetermined law linking the angular acceleration γ to the force applied to the control lever 21 so as to supply a third theoretical force value 100 corresponding to the inertia of the control lever 21.

These three theoretical force values 91, 95, 100 are then added together in an adder 101 so as to provide signals 86 that represent all of the theoretical forces applied to the control lever 21.

The output of the comparator 85 supplies signals 102 that represent the difference ΔF between the measured force signals 72 and the theoretical force signals 86. These signals 102, which represent the difference ΔF of the forces, are fed to the input of a regulation module 103 applying a transfer function representing the response dynamic of the force feedback of the piloting member, which in practice can be a second-order transfer function. The regulation module 103 delivers signals 104 that represent a forces error εF. These forces error signals 104 are fed to the input of a comparator 105 that delivers the monitoring signals 55 as a function of the absolute value of the forces error |εF|.

If this absolute value of the forces error |εF| is higher than a stored predetermined threshold, the monitoring signal 55 is placed at a high level that is adapted to open the switch 62 and to inhibit the electric power supply 63 of the power circuit 64 of the force feedback motors 23. Thus, the force feedback motors 23 are no longer supplied.

If the absolute value of the forces error |εF| is lower than said stored predetermined threshold, the monitoring signal 55 is placed at a low level, which in particular is substantially zero, so that the switch 62 remains closed, with the power circuit 64 being supplied by the electric power supply 63. The force feedback motors 23 are then operational. Of course, an opposite logic to that described above can be used.

The invention can be the subject of various variants of embodiments compared to the examples that are only described above and shown on the drawings. In particular, the various laws implemented in the logic circuits and reference tables can be the subject of various variants. The logics implemented in the various modules and comparators can be more complex and/or can be replaced in part or in whole by equivalent logics. Moreover, the same logic for the implemented monitoring can be the subject of various variants, this monitoring can be direct monitoring, completely or partly cross-monitored between a plurality of piloting members and/or between a plurality of axes or degrees of freedom, with more or less complex automations and regulations, in an open loop and/or in a closed loop. Instead of the generation of monitoring signals, the selected monitoring actions can be the cut-off and the establishment of the electric power supply to the actuating motors, when said motor is supplied by the fly-by-wire flight control system. Similarly, the invention can be the subject of various different applications, for piloting members other than mini-flight sticks, for example for the rudder bars for controlling the yaw of an aircraft or the throttles.

1. A method for monitoring the operation of an aircraft piloting device comprising:
at least one piloting member (20, 30);
at least one fly-by-wire flight control system (40, 41) adapted to generate, as a function of predetermined control laws, signals for controlling actuators (23, 33) of flight control members of said aircraft at least as a function of signals, called primary signals, delivered by sensors associated with each piloting member,
said method for monitoring operation being adapted to detect operating anomalies within said piloting device and to generate corresponding monitoring signals (55, 56) and comprising the following steps:
computing, on the basis of at least part of signals delivered by sensors associated with each piloting member and according to at least one predetermined computation law, at least one theoretical value of at least one operating parameter, called monitored parameter, of at least one piloting member (20, 30);
comparing, for each monitored parameter, each theoretical value with measurement signals delivered by sensors associated with at least one piloting member;
selecting a monitoring action as a function of the difference between each theoretical value and said measurement signals,
characterised in that said at least one theoretical value is computed on the basis of at least part of said primary signals, and in that it is implemented by at least one monitoring module (53, 54) integrated into a fly-by-wire flight control system (40, 41).

2. The method according to claim 1, characterised in that at least one monitored parameter is selected from the position of said piloting member (20, 30) and the forces imparted to said piloting member (20, 30).

3. The method according to claim 2, characterised in that said primary signals comprise position signals delivered by position sensors (22, 32) associated with said piloting member, in that the forces imparted to said piloting member are used by way of monitored parameter, and in that at least one theoretical value of static forces is computed by said monitoring module (53, 54) as a function of a predetermined computation law linking the position with the force.

4. The method according to claim 2, characterised in that said primary signals comprise position signals delivered by position sensors (22, 32) associated with said piloting member, in that the forces imparted to said piloting member are used by way of monitored parameter, and in that at least one theoretical value of damping forces is computed by said monitoring module (53, 54) as a function of a predetermined computation law linking the time drift of the position with the force.

5. The method according to claim 2, characterised in that said primary signals comprise position signals delivered by position sensors (22, 32) associated with said piloting member, in that the forces imparted to said piloting member are used by way of monitored parameter, and in that at least one theoretical value of inertia forces is computed by said monitoring module (53, 54) as a function of a predetermined computation law linking the second time drift of the position with the force.

6. The method according to claim 3, characterised in that at least one theoretical value of forces, which is the algebraic sum of said theoretical values of static, damping and inertia forces, is computed by said monitoring module (53, 54).

7. The method according to claim 1, characterised in that said piloting device comprises at least one actuating motor (23, 33) for at least one piloting member and at least one control unit (60) capable of producing signals, called force feedback signals, for controlling each actuating motor designed to generate a simulated force feedback sensation on said piloting member, in that said monitoring module (53, 54) is executed by at least one central processing unit of a fly-by-wire flight control system distinct from said at least one control unit, and in that said monitoring module (53, 54) is adapted to inhibit at least one force feedback actuating motor when the difference between each theoretical value and said measurement signals is greater by absolute value than a predetermined threshold value corresponding to an operating anomaly.

8. The method according to claim 1, characterised in that a second-order transfer function is used to process an error signal as a function of the difference between each theoretical value and said measurement signals.

9. An aircraft piloting device comprising:
at least one piloting member (20, 30);
at least one fly-by-wire flight control system (40, 41) adapted to generate, as a function of predetermined control laws, signals for controlling actuators of flight control members of said aircraft at least as a function of signals, called primary signals, delivered by sensors associated with each piloting member,
at least one module (53, 54) for monitoring the operation of said piloting device adapted to detect operating anomalies within said piloting device and to generate corresponding monitoring signals, and adapted to:
compute, on the basis of signals delivered by sensors associated with each piloting member and according to at least one predetermined computation law, at least one theoretical value of at least one operating parameter, called monitored parameter, of at least one piloting member;
compare, for each monitored parameter, each theoretical value with measurement signals delivered by sensors associated with at least one piloting member;
select a monitoring action as a function of the difference between each theoretical value and said measurement signals,
characterised in that said at least one monitoring module (53, 54) is integrated into a fly-by-wire flight control system (40, 41), and in that said at least one monitoring module (53, 54) is adapted to compute said at least one theoretical value on the basis of said primary signals.

10. The device according to claim 9, characterised in that at least one monitoring module (53, 54) is adapted to use, by way of monitored parameter, at least one parameter selected from the position of said piloting member and the forces imparted to said piloting member.

11. The device according to claim 9, characterised in that it comprises at least one actuating motor (23, 33) for at least one piloting member and at least one force feedback control unit (60) capable of producing signals, called force feedback signals, for controlling each actuating motor so as to generate a simulated force feedback sensation on said piloting member, and in that said at least one monitoring module is executed by a central processing unit of a fly-by-wire flight control system distinct from said at least one force feedback control unit.

12. The device according to claim 11, characterised in that it comprises at least two piloting members (20, 30) that move along identical degrees of freedom, linked by at least one fly-by-wire flight control system (40, 41) to the same flight control members of said aircraft, and coupled to each other by said force feedback control unit (60).

13. The device according to claim 11, characterised in that at least one monitoring module (53, 54) is adapted to inhibit at least one force feedback actuating motor when the difference between each theoretical value and said measurement signals is greater by absolute value than a predetermined threshold value corresponding to an operating anomaly.

14. An aircraft comprising a piloting device according to claim 9.

15. The device according to claim 12, characterised in that at least one monitoring module (53, 54) is adapted to inhibit at least one force feedback actuating motor when the difference between each theoretical value and said measurement signals is greater by absolute value than a predetermined threshold value corresponding to an operating anomaly.

16. The method according to claim 3, characterised in that said primary signals comprise position signals delivered by position sensors (22, 32) associated with said piloting member, in that the forces imparted to said piloting member are used by way of monitored parameter, and in that at least one theoretical value of damping forces is computed by said monitoring module (53, 54) as a function of a predetermined computation law linking the time drift of the position with the force.

17. The method according to claim 3, characterised in that said primary signals comprise position signals delivered by position sensors (22, 32) associated with said piloting member, in that the forces imparted to said piloting member are used by way of monitored parameter, and in that at least one theoretical value of inertia forces is computed by said monitoring module (53, 54) as a function of a predetermined computation law linking the second time drift of the position with the force.

18. The method according to claim 4, characterised in that said primary signals comprise position signals delivered by position sensors (22, 32) associated with said piloting member, in that the forces imparted to said piloting member are used by way of monitored parameter, and in that at least one theoretical value of inertia forces is computed by said monitoring module (53, 54) as a function of a predetermined computation law linking the second time drift of the position with the force.

19. The method according to claim 4, characterised in that at least one theoretical value of forces, which is the algebraic sum of said theoretical values of static, damping and inertia forces, is computed by said monitoring module (53, 54).

20. The method according to claim 5, characterised in that at least one theoretical value of forces, which is the algebraic sum of said theoretical values of static, damping and inertia forces, is computed by said monitoring module (53, 54).
